(19) United States
(12) Patent Application Publication
(10) Pub. No.: US 2008/0210715 A1
(43) Pub. Date: Sep. 4, 2008

(54) Spout Fitting Apparatus and Container

(75) Inventor: Yoshio Tanaka, Chiba (JP)

Correspondence Address: D. PETER HOCHBERG CO. L.P.A., 1940 EAST 6TH STREET, CLEVELAND, OH, 44114, US

(73) Assignee: Guruppo Pieta Co., Ltd, Chiba (JP)

(21) Appl. No.: 11/886,030

(22) PCT Filed: Mar. 3, 2006
(86) PCT No.: PCT/JP2006/004094

§ 371 Date: Sep. 10, 2007

(30) Foreign Application Priority Data
Mar. 10, 2005 (JP) 2005-067146

(51) Int. Cl. B67D 3/00

(52) U.S. Cl. 222/479

(57) ABSTRACT

A spout fitting apparatus being fixed easily to the spout of a container such as a plastic bottle and a bottle such that the cap of an existing container can be employed, as it is, under fixed state without falling into the container, and fluid flows out smoothly from the container at the time of pouring while preventing a hiccoughing phenomenon due to interruption of fluid flow and preventing fluid from scattering to the surroundings of the container, comprising: a locking portion 1 locking to the spout of a container, an falling-prevention stopper 2 provided at the upper edge of the locking portion 1 and preventing the fitting from dropping into the container, a partition wall 3 bonded to the locking portion 1 and separating the fluid outflow path from the inside of the container and an air inflow path from the outside of the container, and an air inflow conduit 4 for extending the opening from the air inflow path side of the partition wall 3 and connecting it to the inside of the container. A container is also provided.

This application is a National Stage application of International Application No. PCT/JP2006/304094, filed on Mar. 3, 2006, which claims priority of Japanese application No. JP2005-067146 filed on Mar. 10, 2005.

### BACKGROUND OF THE INVENTION

### Field of the Invention

The present invention relates to a spout fitting apparatus and a container having its spout shaped like a spout fitting apparatus, especially for a spout fitting apparatus can be easily attached to a container, such as a plastic bottle and a bottle.

When pouring out the fluid from a container, such as a plastic bottle, a bottle or a can, the inside of the container assumes a negative pressure since the spout of the container is stuffed up with the fluid because of the width of the spout and the viscosity of the fluid itself, when the fluid pours and flows out from the container. For the above-mentioned reason, once the outflow of the fluid stops, the container inhales the air of the same volume as the discharged fluid from the container. Because such a phenomenon occurs repeatedly, the fluid flows out from the container little by little. This phenomenon is called a “hiccup phenomenon”. When “hiccup phenomenon” occurs, it takes much time to pour the fluid from the container and also the fluid flowing out from the container scatters and rebounds. It may cause to spoil the surrounding area of the container.

In order to solve the above-mentioned problems, Japan patent publication number “JP2005-41570” (hereafter called Patent document 1) discloses that the method of securing the airflow path by inserting a straw into an instrument, which can hold the straw, attached on the spout of a plastic bottle or a bottle.

Further, Japan patent publication number “JP2002-249138” (hereafter called Patent document 2) discloses that an attachment attached on the inside of the spout or neck of the spout of a bottle is fitted to a pipe connecting the air trap and the part within a 3 cm radius around a spout of a plastic bottle or a glass bottle.

### SUMMARY OF THE INVENTION

However, among the prior art listed above, according to the Patent document 1 which discloses an instrument that holds the straw in order to secure the airflow path from the inside of the container, there is a deficiency of the instrument easily coming off when the attached straw begins to pour the fluid from the container.

And, according to the Patent document 2 which discloses an attachment, attached on the inside of the spout or neck of the spout of a bottle, which is fitted to a pipe connecting the air trap and the part within a 3 cm radius around a spout of a plastic bottle or a glass bottle, there is a deficiency that an original cap is not able to use as a usual tab when the size of the stopper is bigger than that of the spout. Further, there is a deficiency that the stopper falls into the container when the size of the stopper is smaller than that of the spout.

The purpose of the present invention is to provide a spout fitting apparatus and a container having the same construction as an integral spout fitting apparatus which is very easy to attach on the spout of the container such as a plastic bottle or a bottle, without falling into a container, whereby a consumer can use an original cap of a plastic bottle or a bottle as a usual tab, further by attaching the spout fitting apparatus at the spout of the container, the flow of the fluid becoming smooth without occurring hiccup phenomenon when pouring or flowing out the fluid from the container, so that it can prevent it from scattering fluid around the container.

To solve the above-mentioned problems, the present invention is characterized by a spout fitting apparatus attached with a opening of the container such as a plastic bottle or a bottle comprising: a locking portion locking to the spout of a container, a falling prevention stopper provided at the upper edge of the locking portion, a partition wall bonded to the locking portion and separating the fluid outflow path from the inside of the container, and an air inflow conduit for extending the opening from the air inflow conduit side of the partition wall and connecting it to the inside of the container, wherein the spout fitting apparatus is fixed easily to the spout of the container such as a plastic bottle or a bottle.

To solve the above-mentioned problems, a portion of the present invention is characterized by the spout fitting apparatus in accordance with the basic invention, wherein the locking portion adheres to the inner wall of the spout of the container for at least more than semicircle of the spout and has an elastic force in the direction which extends to the inner wall of the spout.

To solve the above-mentioned problems, the present invention in another aspect is characterized by the spout fitting apparatus in accordance with the basic invention, wherein the air inflow conduit curves along the inclination of the inside of the container, and a head of the air inflow conduit extends to the shoulder part of the container.

To solve the above-mentioned problems, another aspect of the present invention is characterized by the spout fitting apparatus in accordance with the previous aspect of the invention, wherein the opening of the head of the air inflow conduit is cut crosswise in order to face to the inner wall of the container.

To solve the above-mentioned problems, a further aspect of the present invention is characterized by a container having a spout, such as a plastic bottle or a bottle, comprising: a partition wall connected with the spout of the container and separating the outflow path of the fluid from the inside of the container and the inflow path of the air from the outside of the container, and an air inflow conduit for extending the opening from the air inflow conduit side of the partition wall and connecting it to the inside of the container.

According to the present invention, the spout fitting apparatus designed as described in the above explanation, is very easy to attach on the spout of the container such as a plastic bottle or a bottle without falling into a container, and a consumer can use an original cap of a plastic bottle or a bottle as a usual tab. By attaching the spout fitting apparatus at the spout of the container, the flow of the fluid becomes smooth without occurring hiccup phenomenon when pouring out the fluid from the container, so that it can prevent from scattering fluid around.

Further, according to the present invention, since the spout fitting apparatus is designed as described in the above explanation, the flow of the fluid becomes smooth without occurring hiccup phenomenon when pouring out the fluid from the container with the pouring part located upwards, so that it can prevent the scattering fluid.

### BRIEF DESCRIPTION OF THE DRAWINGS

FIG. 1 shows a schematic perspective view of the present invention.

FIG. 2 shows a schematic perspective view of the present invention attached with the spout of a container, such as a plastic bottle and a bottle, pouring out the fluid from the spout.

### DETAILED DESCRIPTION OF THE PREFERRED EMBODIMENTS

The present invention will be explained hereunder in detail based upon examples with reference to the accompanying drawings.

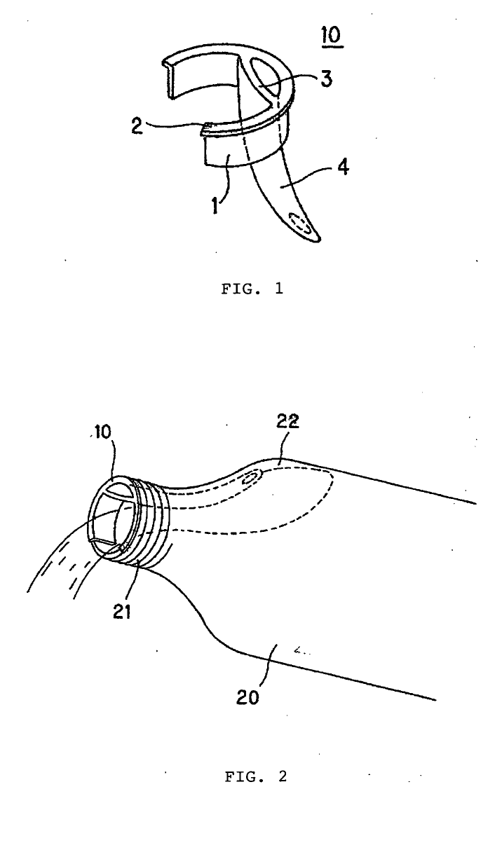

FIG. 1 shows a schematic perspective view of the present invention “Spout fitting apparatus” and FIG. 2 shows a schematic perspective view of the present invention “Spout fitting apparatus” attached with the spout of a container, such as a plastic bottle and a bottle, pouring out the fluid from the spout.

As shown in FIG. 1 and FIG. 2, a spout fitting apparatus 10 in the present invention consists of locking portion 1, falling-prevention stopper 2, partition wall 3 and air inflow conduit 4. A container 20, which is usually known as a plastic bottle or a bottle, consists of spout 21 and shoulder 22.

In the present invention, the locking portion 1 of the spout fitting apparatus 10 comprises a tubular type of vertical division so that it can be inserted in the spout 21 of the container 20 and has the elastic force in the direction that extends to the inner wall of the spout 21. Therefore, the spout fitting apparatus 10 can be easily attached with various sizes of spouts of containers. The locking portion 1 of the spout fitting apparatus 10 adheres to the inner wall of the spout 21 of the container 20 for at least more than semicircle of the spout 21 when the locking portion 1 is inserted in the spout 21 of the container 20.

The falling-prevention stopper 2 is provided at the upper edge of the locking portion 1. When the looking portion 1 is inserted in the spout 21 of the container 20, the falling-prevention stopper 2 is hooked up with the upper edge of the spout 21 so that the spout fitting apparatus does not fall into the container 20.

The partition wall 3 is formed in the locking portion 1 in order to separate the outflow path of the fluid from the inside of the container 20 and the inflow path of the air from the outside of the container 20, and the air inflow conduit 4 is extended inside the container 20 from the air inflow side. The air inflow conduit 4 curves along the inclination of the inside of the container 20, and the head of the air inflow conduit 4 extends to the shoulder part of the container 20. The opening of the head of the air inflow conduit 4 is cut crosswise in order to face the inner wall of the container 20 so that the inflow of air from the outside to the shoulder 22 is performed easily. Since the partition wall 3 does have the predetermined curvature against the locking portion 1, it does not become an obstacle by bending easily even if the diameter of the spout 21 of the container 20 is small.

If the direction to which the spout fitting apparatus 10 attached is turned upward and the fluid inside of the container 20 is poured out, when the spout fitting apparatus 10 is inserted in the spout 21 of the container 20 and the locking portion 1 is attached to the upper edge of the spout 21, the air comes into the inside of the container 20 through the air inflow conduit 4 from the air inflow path located at the upper side of the partition wall 3, and the fluid inside of the container comes out continuously through the lower side of the partition wall 3. Therefore, the flow of the fluid is stabilized and the hiccup phenomenon does not occur so that the fluid flows out smoothly without scattering around.

When the spout fitting apparatus 10 is attached to the container 20, most of the spout fitting apparatus 10 is stored in the container 20 except for the slight part of falling-prevention stopper 2 because of its thickness. Therefore, after attaching the spout fitting apparatus 10 with the spout 21, it does not become obstructive and the original cap is used as it is.

In the present invention, the spout fitting apparatus can be formed by thermoplastics, such as polyethylene, polystyrene, and nylon. The locking portion 1 has elasticity and the spout fitting apparatus has a suitable length. Therefore, it can be adapted for changes of various diameters of the spout 21, and it can be used with various containers 20.

According to the construction of the present invention “spout fitting apparatus 10” designed as described above, by attaching the spout fitting apparatus 10 at the spout 21 of the container 20, the flow of the fluid becomes smooth without incurring the hiccup phenomenon when pouring the fluid out of the container 20, so that it can prevent the scattering of fluid around and does not take much time in order to pour the fluid from the container 20.

According to the present invention, the locking portion 1 has elasticity and the spout fitting apparatus has a suitable length. Therefore, it can be adapted for changes of various diameters of the spout 21, and can be used with various containers 20. The falling-prevention stopper 2 is configured so that the spout fitting apparatus 2 does not fall into the container 20. Most of the spout fitting apparatus 10 is stored in the container 20 except for the slight part of the falling-prevention stopper 2 because of its thickness so that it does not become obstructive, and the original cap is used as it is. Further, the spout fitting apparatus is very light in weight and can be manufactured at low cost. Therefore, there is no substantial burden of the user by attaching the spout fitting apparatus with a plastic bottle or a bottle.

Although the above explanation was described about the spout fitting apparatus, if the structure of the spout of the container is part of the same structure as the spout fitting apparatus, and is formed integrally with the latter when manufacturing, the container also has the same effect as of the spout fitting apparatus. The above-mentioned construction can be manufactured easily by using thermoplastic resin etc. and a die. Therefore, it is not expensive considering the structure of the spout fitting apparatus, and large-scale production is possible.

The present invention “Spout fitting apparatus and container” can be used for a plastic bottle and a bottle containing water, fruit juice, fluid seasoning, oil, paint, fluid detergent, and medicine, and can use the container of this invention in a wide range of industrial fields.

Having described preferred methods of putting the invention into effect, it will be apparent to those skilled in the art to which this invention relates, that modifications and amendments to various features and items can be effected and yet still come within the general concept of the invention. It is to be understood that all such modifications and amendments are intended to be included within the scope of the present invention.

1. A spout fitting apparatus attachable to an opening of a container such as a plastic bottle or a bottle, the container having a spout with an innerwall, said apparatus comprising:
a locking portion lockable to the spout of a container,
a falling-prevention stopper provided at the upper edge of the locking portion,
a partition wall bonded to the locking portion and separating the fluid outflow path from the inside of the container, said partition wall having an opening and forming an air flow conduit side, and
an air inflow conduit extending the opening from the air inflow conduit side of the partition wall and connecting said air flow conduit side to the inside of the container, said air inflow conduit having a head,
wherein the spout fitting apparatus is fixed easily to the spout of the container such as a plastic bottle or a bottle.

2. The spout fitting apparatus in accordance with claim 1 wherein the spout is circular in cross-section, and wherein the locking portion adheres to the inner wall of the spout of the container at least more than semicircle of the spout and has the elastic force in the direction extending to the inner wall of the spout.

3. The spout fitting apparatus in accordance with claim 1,
wherein the container has an inside inclination and a shoulder part, and the air inflow conduit curves along the inclination of the inside of the container, and
said head of the air inflow conduit extends to the shoulder part of the container.

4. The spout fitting apparatus in accordance with claim 3, wherein the opening of the head of the air inflow conduit is cut crosswise in order to face to the inner wall of the container.

5. A container having a spout such as a plastic bottle or a bottle comprising:
a partition wall connected with the spout of the container and separating the outflow path of the fluid from the inside of the container and the inflow path of the air from the outside of the container, and
an air inflow conduit for extending the opening from the air inflow conduit side of the partition wall and connecting it to the inside of the container.
